(19) United States
(12) Patent Application Publication
(10) Pub. No.: US 2019/0299502 A1
(43) Pub. Date: Oct. 3, 2019

(54) LOCAL REINFORCEMENT OF INJECTION MOLDINGS

(71) Applicant: Hilti Aktiengesellschaft, Schaan (LI)

(72) Inventor: Ernst-Rudolf LUEBKERT, Lamdsberg am Lech (DE)

(21) Appl. No.: 16/331,290

(22) PCT Filed: Sep. 6, 2017
(86) PCT No.: PCT/EP2017/072356

§ 371 Date: Mar. 7, 2019

(30) Foreign Application Priority Data
Sep. 13, 2016 (EP) 16188479.6

(51) Int. Cl. B29C 45/00; B29C 45/14; B29C 45/18; B29C 45/27

(52) U.S. Cl. CPC B29C 45/0005; B29C 45/14032; B29L 2031/28; B29C 45/1816; B29C 45/2737; B29C 45/14786

(57) ABSTRACT

A method for using an injection mold for manufacturing plastic components, in particular components of power tools, the injection mold containing a sprue plate, a push-in device and an ejector plate. A cavity is between the sprue plate and the ejector plate when the sprue plate and the ejector plate are in an assembled state, and the ejector plate containing a fiber channel, through which a fiber bundle having a thermoplastic matrix is transportable to the cavity, via the push-in device, along at least part of the sprue plate. The method includes assembling the sprue plate and the ejector plate; heating the fiber bundle together with the thermoplastic matrix; positioning the fiber bundle at the cavity via the push-in device; introducing a liquid plastic into the cavity through a channel of the sprue plate; and introducing the fiber bundle into the cavity so that the fiber bundle is positioned in the cavity by the stream of liquid plastic.

The present invention relates to a method for using an injection mold for manufacturing plastic components, in particular components of power tools, the injection mold containing at least one sprue plate, a push-in device and an ejector plate, and at least one cavity being provided between the sprue plate and the ejector plate when the sprue plate and the ejector plate are in an assembled state, and the ejector plate containing at least one fiber channel, through which at least one fiber bundle having a thermoplastic matrix is transportable to the cavity, with the aid of the push-in device, along at least part of the sprue plate.

The present invention also relates to an injection mold for using the method.

The invention furthermore relates to plastic components, in particular components of power tools, manufactured in the method.

### BACKGROUND

Components made from plastic, e.g. polyamide, and in particular components manufactured by an injection molding process, do not have a particularly high breaking strength. For example, one problem is that a housing component manufactured from plastic in an injection molding process, e.g. a housing for a power tool, may break in different locations when it strikes a hard substrate from a certain height. A striking of this type may take place, for example, as a result of a fall, for example from a scaffolding. In certain circumstances, part of the housing or the entire housing of a power tool may become so heavily damaged after a fall that a replacement of the damaged housing component or even the entire housing is necessary.

### SUMMARY OF THE INVENTION

It is an object of the present invention to solve the aforementioned problem and, in particular, to provide a method, with the aid of which the possibility of damage to a component manufactured in an injection molding process, in particular a housing of a power tool, may be mitigated. A further alternate or additional object is to provide an injection mold for use in the method according to the present invention.

The present invention also provides a method for using an injection mold for manufacturing plastic components, in particular components of power tools, the injection mold containing at least one sprue plate, a push-in device and an ejector plate, and at least one cavity being provided between the sprue plate and the ejector plate when the sprue plate and the ejector plate are in an assembled state, and the ejector plate containing at least one fiber channel, through which at least one fiber bundle having a thermoplastic matrix is transportable to the cavity, with the aid of the push-in device, along at least part of the sprue plate.

According to the present invention, the following steps are provided for the method:
Assembling the sprue plate and the ejector plate;
Heating the at least one fiber bundle together with the thermoplastic matrix;
Positioning the at least one fiber bundle at the cavity with the aid of the push-in device;
Introducing a liquid plastic into the cavity through at least one channel of the sprue plate; and
Introducing the at least one fiber bundle into the cavity, so that the fiber bundle is positioned in the cavity by the stream of liquid plastic.

This makes it possible to ensure that a component manufactured in an injection molding process is locally reinforced by introducing fibers in specific locations at which the component is exposed to great mechanical forces. By inserting the fibers, plastic used in the injection molding process may thus be reinforced locally or even as a whole.

The present invention also provides an injection mold for using the method.

The present invention also provides plastic components, in particular components of power tools, manufactured in the method.

According to the present invention, it is provided that the injection module contains at least one sprue plate as well as an ejector plate, and at least one cavity being provided between the sprue plate and the ejector plate when the sprue plate and the ejector plate are in an assembled state, and the ejector plate containing at least one fiber channel, through which at least one fiber bundle is transportable to the cavity along at least part of the sprue plate. This makes it possible to ensure that a component manufactured in an injection molding process is locally reinforced by inserting fibers at specific locations, at which the component is exposed to great mechanical forces. By inserting the fibers, plastic used in the injection molding process may thus be reinforced locally or even as a whole.

According to one advantageous specific embodiment of the present invention, it may be possible that a push-in device including a cylindrical push-in element is provided, the cross-sectional surface of the push-in element essentially corresponding to a cross-sectional surface of the fiber channel, so that the push-in element is reversibly movable in the fiber channel, and a fiber bundle present in the fiber channel is transportable through the fiber channel and into the cavity by the push-in element. The insertion of the fiber bundle into the cavity and to the liquid plastic in the cavity may be effectively controlled thereby, and the point in time at which the fiber bundle is introduced into the cavity and into the liquid plastic may be varied. Due to the targeted and predetermined introduction of the fiber bundle into the liquid plastic, the final position of the fiber bundle in the cavity and in the liquid plastic may be determined.

According to another advantageous embodiment of the present invention, it may be possible that the ejector plate contains at least one carrier element having a through-hole for receiving at least one fiber bundle, the carrier element, together with the fiber bundle, being insertable into the through-hole in the ejector plate in such a way that the fiber bundle is positioned in the fiber channel, the carrier element containing at least one heating element for heating a fiber bundle positioned in the carrier element. A fiber bundle positioned in the carrier element may be heated hereby for better processing and be easily positioned in the fiber channel.

Other advantages result from the following description of the figures. The figures illustrate different exemplary embodiments of the present invention. The figures, the description and the claims contain numerous features in combination. Those skilled in the art will advantageously also consider the features individually and combine them to form other meaningful combinations.

### BRIEF DESCRIPTION OF THE DRAWINGS

In the figures, identical and equivalent components are provided with identical reference numerals.

FIG. 1 shows a side view of an injection molding machine, including an injection mold;

FIG. 2a shows an ejector plate of an injection mold, including a centering flange and a carrier element;

FIG. 2b shows a sectional view along section line A-A in FIG. 2a of the injection mold, including the ejector plate, a first mounting plate, the carrier element, a push-in device, a sprue plate and a second mounting plate in an assembled state;

FIG. 3 shows a sectional view of a through-hole of the carrier element, including a fiber bundle;

FIG. 4 shows a sectional view along section line A-A in FIG. 2a of the injection mold, including the ejector plate, the carrier element, the push-in device, the sprue plate and the fiber bundle in an assembled state;

FIG. 5 shows a sectional view of the carrier element, including a heating element, the fiber bundle having a thermoplastic matrix, the ejector plate and a push-in element of the push-in device;

FIG. 6 shows a sectional view along section line A-A in FIG. 2a of the injection mold, including the ejector plate, the carrier element, the push-in device, the sprue plate, the fiber bundle and the liquid plastic in an assembled state;

FIG. 7 shows a sectional view of the cavity, part of the ejector plate, part of the carrier element, part of the push-in element, the fiber bundle, the liquid plastic and part of the sprue plate, the cavity being filled approximately halfway with the liquid plastic;

FIG. 8 shows a sectional view along section line A-A in FIG. 2a of the injection molding machine, including the ejector plate, the carrier element, the push-in device, the sprue plate, the fiber bundle and the liquid plastic in an assembled state, the cavity being filled approximately halfway with the liquid plastic;

FIG. 9 shows a detailed view of part of the ejector plate, part of the push-in element, the fiber bundle, part of the liquid plastic and part of the sprue plate, the cavity being filled approximately halfway with the liquid plastic;

FIG. 10 shows a sectional view along section line A-A in FIG. 2a of the mold, including the ejector plate, the carrier element, the push-in device, the sprue plate, the fiber bundle and the liquid plastic in an assembled state;

FIG. 11 shows a detailed view of part of the ejector plate, part of the push-in element, the fiber bundle, part of the liquid plastic and part of the sprue plate; and

FIG. 12 shows a sectional view along section line A-A in FIG. 2a of the mold, including the ejector plate, the carrier element, the push-in device, the sprue plate, the fiber bundle and the cured plastic in an opened state.

### DETAILED DESCRIPTION

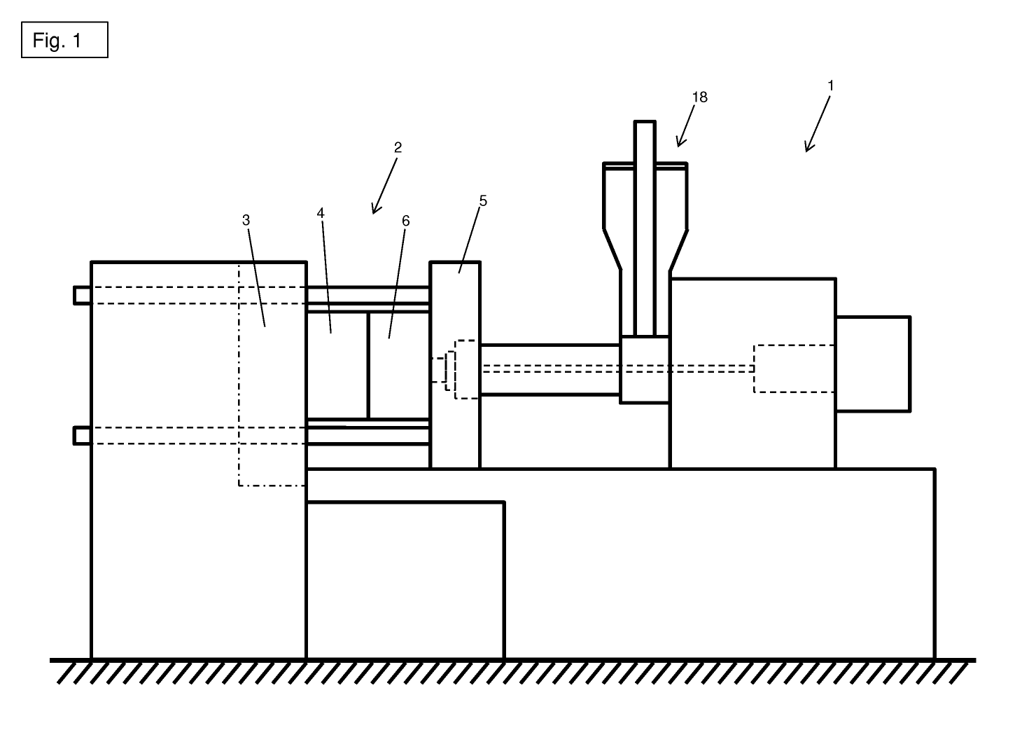

FIG. 1 shows an injection molding machine 1, including an injection mold 2. Injection mold 2 essentially contains a first mounting plate 3, including an ejector plate 4, a second mounting plate 5, including a sprue plate 6, a push-in device 7 and a carrier element 8.

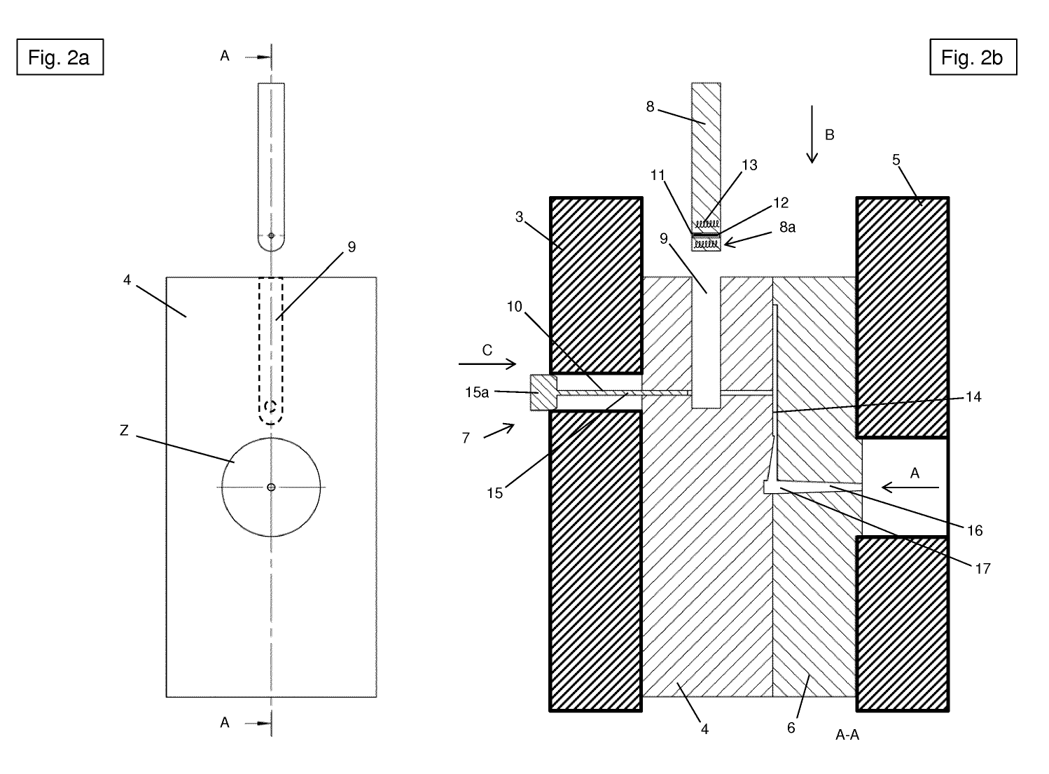

FIGS. 2a and 2b show a schematic representation of injection mold 2 for manufacturing plastic components.

Injection mold 2 may also be referred to as a mold for an injection molding machine. The plastic components may be parts, such as housing components of power tools.

As illustrated in FIG. 2b, ejector plate 4 is essentially designed as a rectangular block and includes a push-in opening 9 and a fiber channel 10. Sprue plate 6, including a centering flange Z, is illustrated in FIG. 2a.

Push-in opening 9 is essentially provided with a rectangular design and extends in ejector plate 4 in direction B. Carrier element 8 may be inserted into push-in opening 9. Carrier element 8 has a certain clearance fit when it is situated in push-in opening 9.

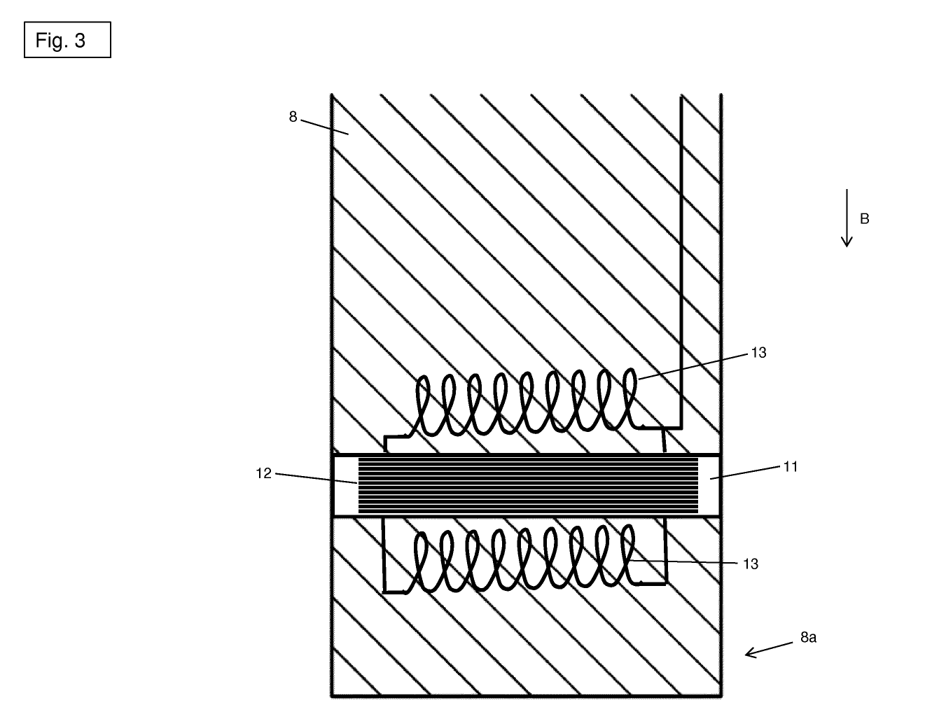

Carrier element 8 is essentially designed as a rectangular block. At a front end 8a, carrier element 8 has a through-hole 11 for receiving at least one fiber bundle 12. Heating elements 13 in the form of a heating wire are positioned around through-hole 11 (cf. FIG. 3). Heating elements 13 are used to heat fiber bundle 12 in through-hole 11. The diameter of through-hole 11 is circular and is 2 mm to 3 mm. Through-hole 11 is approximately 22 mm long in direction C. In the illustrated exemplary embodiment, through-hole 11 has a circular diameter of 2.5 mm. Fiber bundle 12 is a bundle of carbon fibers having a thermoplastic matrix. Each fiber of fiber bundle 12 is approximately 20 mm long. The fiber of fiber bundle 12 is approximately 5% to 10% shorter than the length of through-hole 11. The diameter of fiber bundle 12 is circular, is approximately 2 mm to 3 mm and is adapted to the diameter of through-hole 11. In other words, the diameter of fiber bundle 12 is always smaller than the diameter of through-hole 11. However, the diameter of fiber bundle 12 does not necessarily have to be circular, but the latter may also have a rectangular or square diameter. It is also possible, however, to use a material other than carbon, such as glass or aramides. Moreover, it is also possible for the fibers to be longer or shorter than 22 mm. As illustrated in FIG. 2b, through-opening 11 extends through carrier element 8 in direction A. Fiber channel 10 extend along the entire width of ejector plate 4 and against direction A. Cylindrical fiber channel 10 is used to introduce a fiber bundle 12 through ejector plate 4 and up to a cavity 14. Cavity 14 is situated between ejector plate 4 and sprue plate 6 when ejector plate 4 and sprue plate 6 are in an assembled state (cf. FIG. 2b).

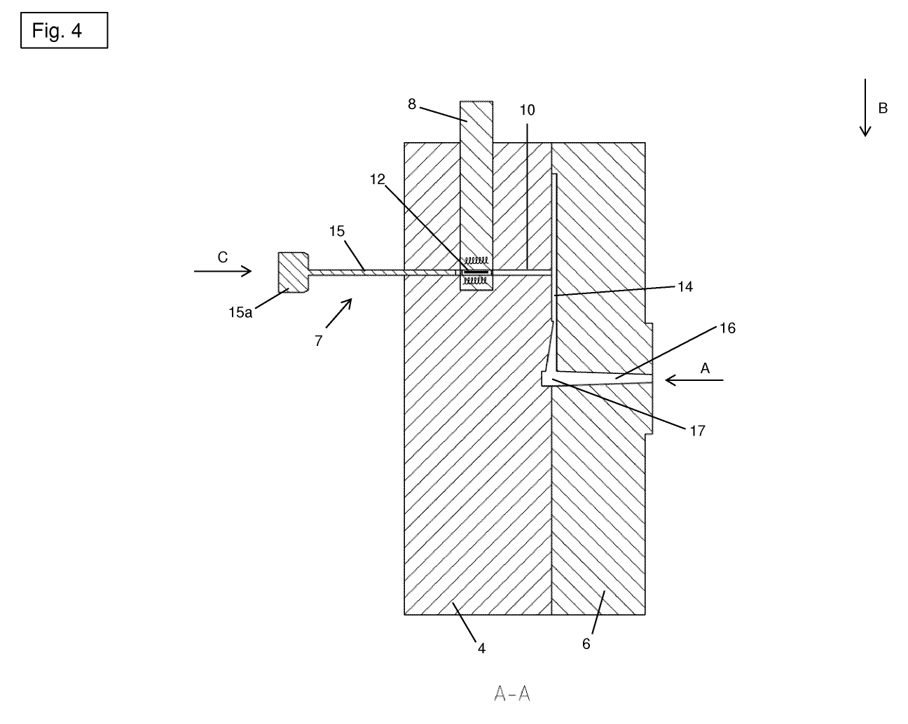

Push-in opening 9 and fiber channel 10 intersect in such a way that through-hole 11 of carrier element 8 is in an alignment with fiber channel 10, and through-hole 11 is situated in the middle of the cross-sectional surface of fiber channel 10 when carrier element 8 is located all the way in push-in opening 9 (cf. FIG. 4).

Push-in device 7 contains a cylindrical push-in element 15. Push-in element 15 may also be referred to as a pin. A stop 15a is situated at a free end of push-in element 15. The cross-sectional surface of push-in element 15 essentially corresponds to a cross-sectional surface of fiber channel 10, so that push-in element 15 is reversibly movable within fiber channel 10, and a fiber bundle 12 situated in fiber channel 10 is transportable through fiber channel 10 and into cavity 14 by push-in element 15.

Sprue plate 6 is essentially designed as a rectangular block and contains a sprue channel 16 and a cavity recess 17. Centering flange Z is furthermore provided on one side of sprue plate 6. Centering flange Z is used to position sprue plate 6 in a certain alignment and arrangement with respect to injection molding machine 1. Due to sprue channel 16, liquid plastic may enter cavity recess 17 through sprue plate 6 and thus also cavity 14, which is situated between ejector plate 4 and sprue plate 6 in an assembled state.

### Injection-Molding Process:

To manufacture components in the injection molding process, ejector plate 4 and sprue plate 6 are initially assembled in such a way that cavity 14 forms between ejector plate 4 and sprue plate 6. For this purpose, ejector plate 4 is moved in direction C (cf. FIGS. 2a and 2b).

Carrier element 8 is situated outside the push-in opening against direction B. A fiber bundle 12 is positioned in through-hole 11 of carrier element 8 (cf. FIG. 3). The fibers of fiber bundle 12 are slightly wavy and not completely extended when the fibers are in through-hole 11 of carrier element 8. Push-in element 15 is situated so far in direction A that push-in element 15 does not project into push-in opening 9.

Fiber bundle 12 is heated in carrier element 8 with the aid of heating element 13.

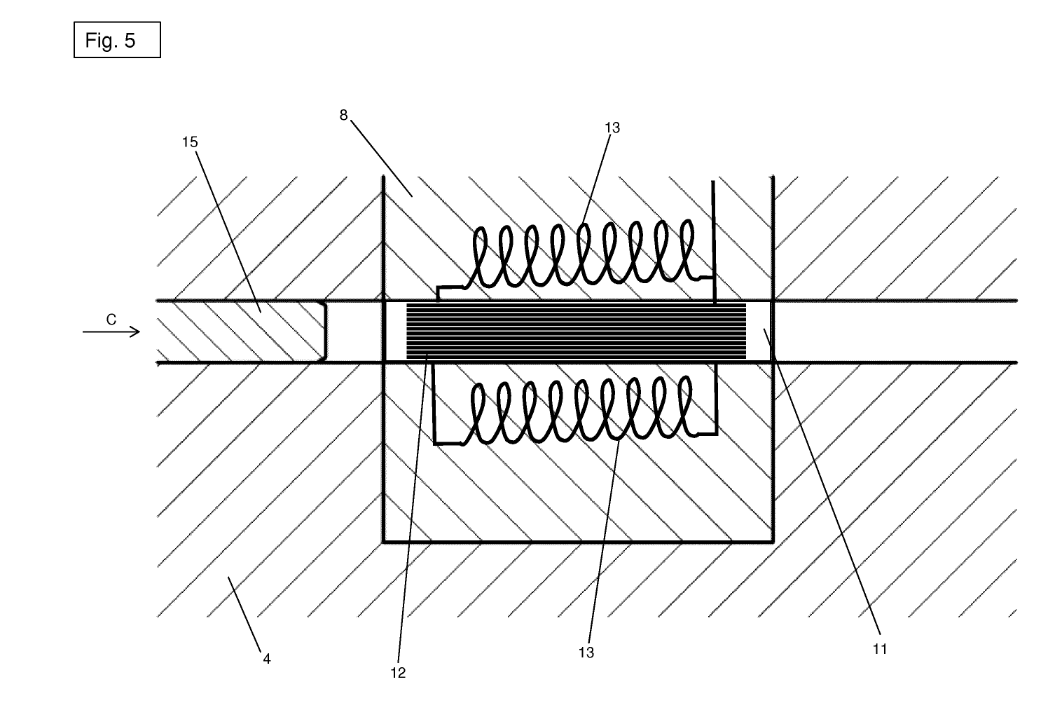

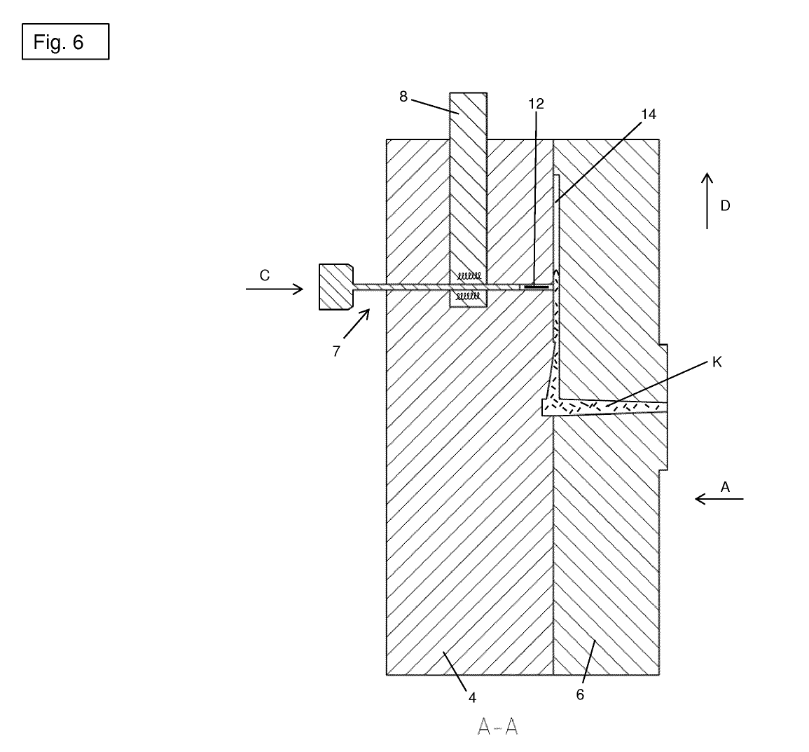

Next, carrier element 8, together with fiber bundle 12 in through-hole 11, is inserted all the way into push-in opening 9, so that fiber bundle 12 in through-hole 11 is positioned in the middle of fiber channel 10 (cf. FIG. 4). However, liquid plastic K is not introduced into sprue channel 16 until fiber bundle 12 is situated at cavity 14 (cf. FIG. 6). Plastic K is heated to become liquid. Device 18 for introducing the liquid plastic is illustrated in FIG. 1. Push-in element 8 is moved in direction C so that end 8a of push-in element 8 finally rests against fiber bundle 12 (cf. FIGS. 4 and 5).

As illustrated in FIG. 6, fiber bundle 12 is pushed to cavity 14 along fiber channel 10 in direction C. Liquid plastic K has now filled cavity 14 halfway. Liquid plastic K continues to flow in direction A and in direction D. The point in time of the inflow of liquid plastic K varies, depending on where the fibers of fiber bundle 12 are ultimately to be positioned in plastic K. To position the fibers in plastic K of the component farther to the front in direction C, the fibers are already introduced into cavity 14 when only a small amount of liquid plastic K is in cavity 14. To position the fibers in plastic K of the component farther to the rear in direction C, the fibers are not introduced into cavity 14 until more liquid plastic K is already in cavity 14.

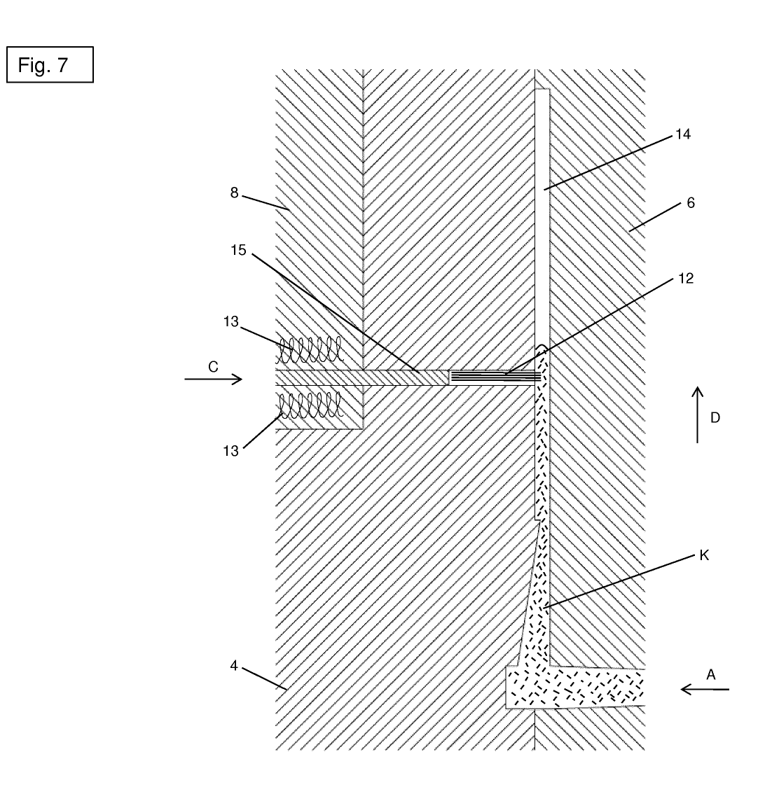

As illustrated in FIG. 7, the ends of the fibers finally strike liquid plastic K in cavity 14, liquid plastic K continuing to move in directions A and D. Push-in element 8 presses fiber bundle 12 farther in direction C.

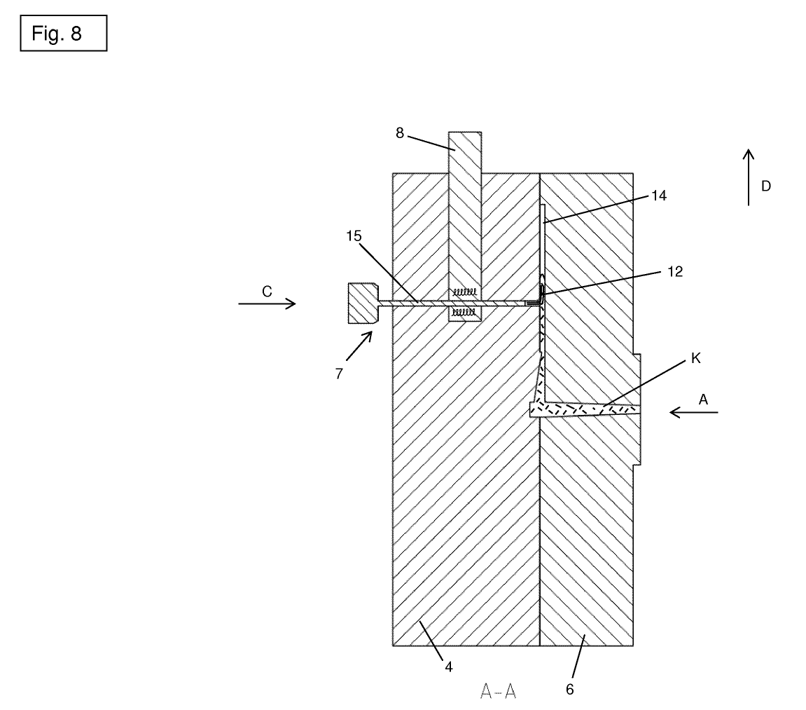

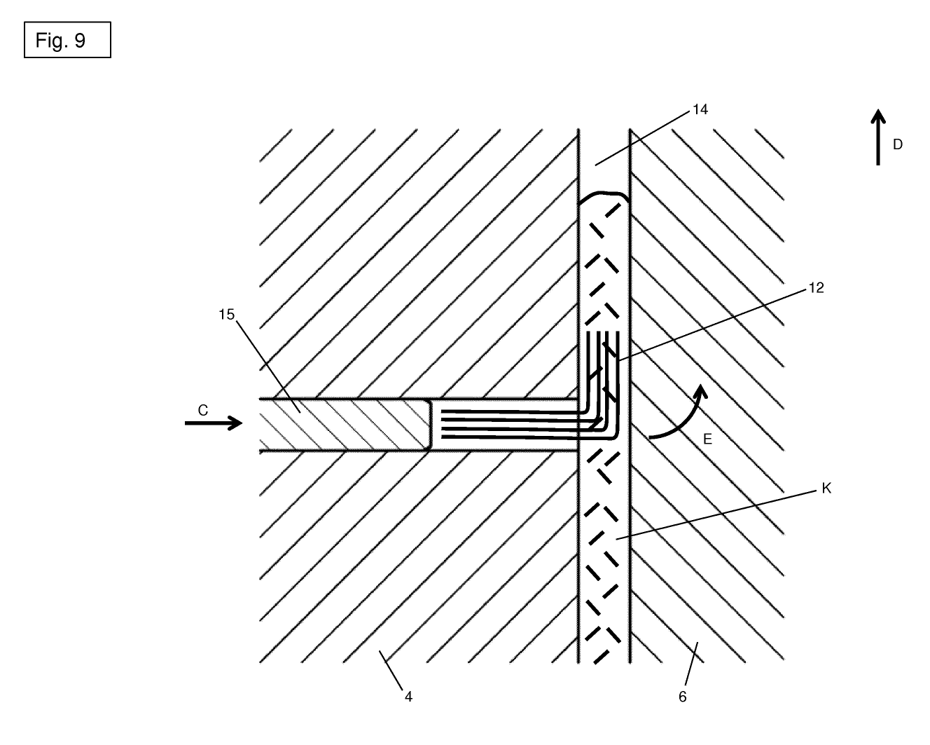

The individual fibers of fiber bundle 12 are finally carried along by liquid plastic K when liquid plastic K continues to move in direction D and the fibers continue to move in an arc in direction E. Push-in element 8 continues to move in direction C (cf. FIG. 8).

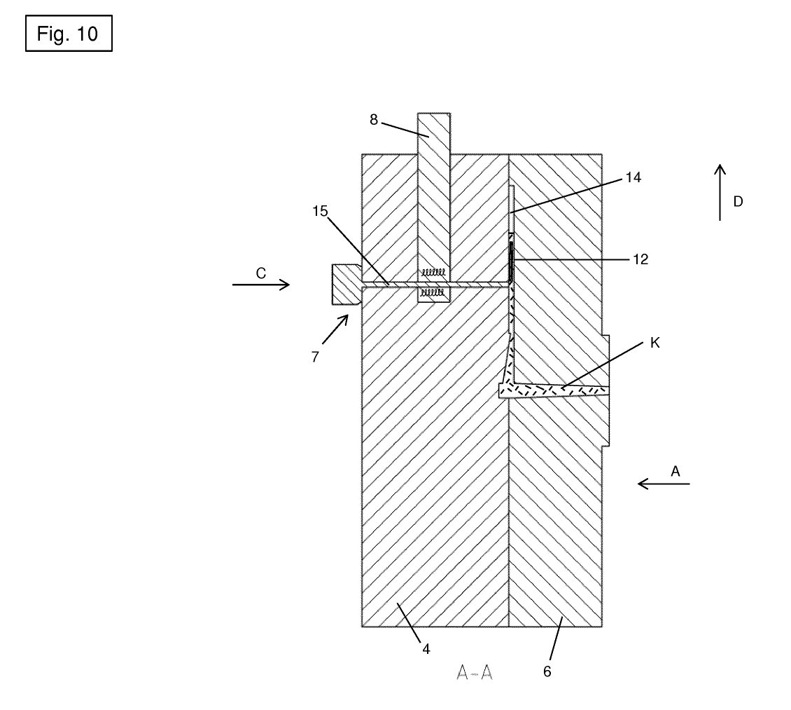

Finally, the fibers of fiber bundle 12 are completely encompassed by liquid plastic K and have been drawn into cavity 14. Liquid plastic K continues to move in directions A and D. Due to liquid plastic K, which continues to flow, the fibers of fiber bundle 12 are positioned in liquid plastic K. Push-in element 8 is now fully adjacent to ejector plate 4, i.e. inserted all the way, in fiber channel 10 (cf. FIG. 10). However, it is also possible that the fibers of fiber bundle 12 displace liquid plastic K in cavity 14 and thus move into an area of cavity 14, in which no liquid plastic K is yet present.

Moreover, it is also possible that fiber bundle 12 is not inserted into cavity 14 until cavity 14 is almost completely filled with liquid plastic K, and only the volume of fiber bundle 12 may be inserted into cavity 14 to completely fill cavity 14. The remaining volume of cavity 14 until being filled completely corresponds to the volume of fiber bundle 12.

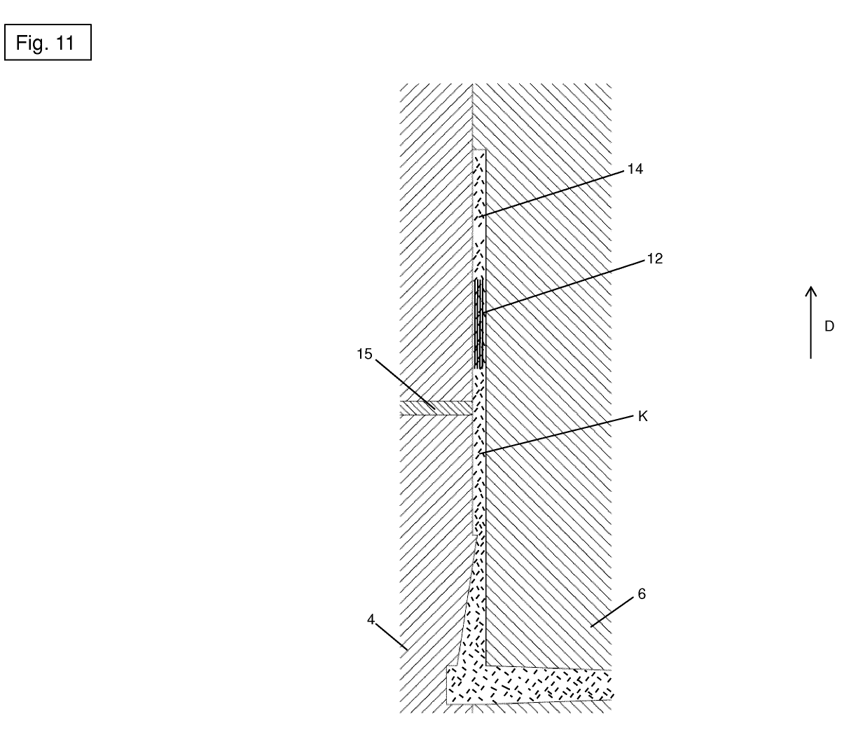

When liquid plastic K completely fills cavity 14, plastic K no longer moves, and the fibers have reached the end position (cf. FIG. 11). The position of fiber channel 10 in ejector plate 4 may be varied to control the end position of the fibers. Moreover, it is also possible that the point in time at which push-in element 8 pushes fiber bundle 12 to cavity 14 through fiber channel 10, the speed of fiber bundle 12 in fiber channel 10 and/or the speed of liquid plastic K in cavity 14 or the diameter of fiber bundle 12 is varied.

It should be noted that the fibers are not fully extended when they are situated in liquid plastic K and in the end position.

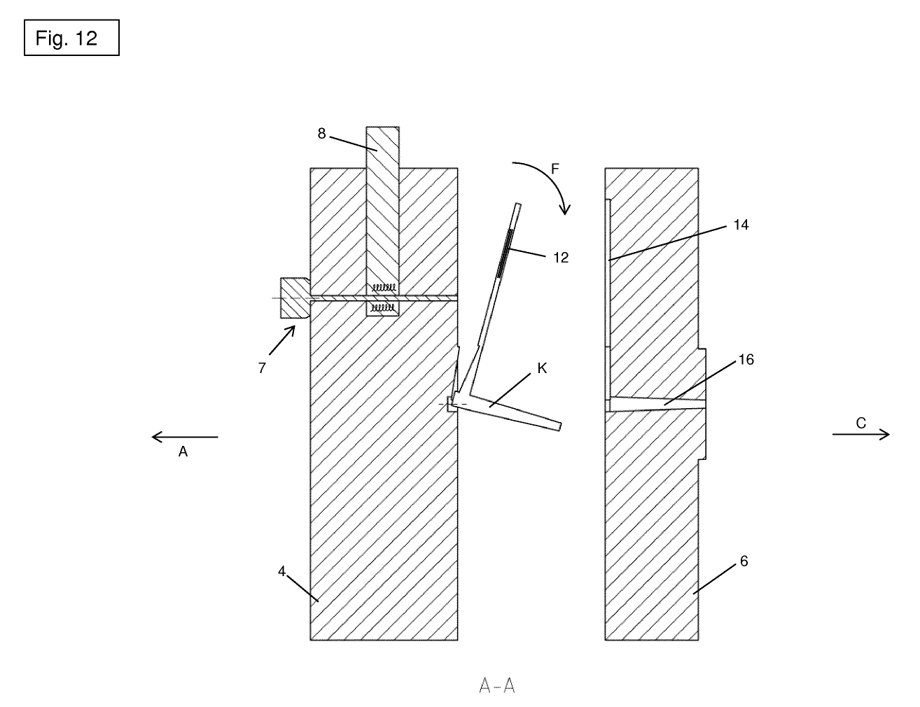

After plastic K has been cooled and cured, ejector plate 4 and sprue plate 6 are again separated from each other. For this purpose, ejector plate 4 is moved in direction A. Cavity 14 between ejector plate 4 and sprue plate 6 is exposed, and the component manufactured in the injection molding process may be removed from ejector plate 4 by pivoting it in direction F and pulling it in direction C (cf. FIG. 12).

What is claimed is:

1-5. (canceled)

6. A method for using an injection mold for manufacturing plastic components, the injection mold including at least one sprue plate, a push-in device and an ejector plate, at least one cavity being provided between the sprue plate and the ejector plate when the sprue plate and the ejector plate are in an assembled state, the ejector plate including at least one fiber channel, at least one fiber bundle having a thermoplastic matrix being transportable to the cavity via the at least one fiber channel, with the aid of the push-in device, along at least part of the sprue plate, the method comprising the following steps:
assembling the sprue plate and the ejector plate;
heating the at least one fiber bundle together with the thermoplastic matrix;
positioning the at least one fiber bundle at the cavity with the aid of the push-in device;
introducing a liquid plastic into the cavity through at least one sprue channel of the sprue plate; and
introducing the at least one fiber bundle into the cavity, so that the fiber bundle is positioned in the cavity by the stream of liquid plastic.

7. The method as recited in claim 6 wherein the plastic components are components of power tools.

8. An injection mold for the method as recited in claim 6, the injection mold comprising:
at least one sprue plate: and
an ejector plate, at least one cavity being provided between the sprue plate and the ejector plate when the sprue plate and the ejector plate are in an assembled state, the ejector plate containing at least one fiber channel, at least one fiber bundle being transportable to the cavity along at least part of the sprue plate via the at least one fiber channel.

9. The injection mold as recited in claim 8 further comprising a push-in device including a cylindrical push-in element, a cross-sectional surface of the push-in element corresponding to a cross-sectional surface of the fiber channel, so that the push-in element is reversibly movable within the fiber channel, and the fiber bundle situated in the fiber channel is transportable through the fiber channel and into the cavity by the push-in element.

10. The injection mold as recited in claim 8 wherein the ejector plate includes at least one carrier element having a through-hole for receiving the at least one fiber bundle, the carrier element, together with the fiber bundle, being insertable into the through-hole in the ejector plate in such a way that the fiber bundle is positioned in the fiber channel, the carrier element including at least one heating element for heating a fiber bundle positioned in the carrier element.

11. Plastic components manufactured according the method as recited in claim 6.

12. Plastic components of power tools manufactured according the method as recited in claim 6.
